(19) United States
(12) Patent Application Publication
(10) Pub. No.: US 2004/0065062 A1
(43) Pub. Date: Apr. 8, 2004

(54) Adjustable equine saddle tree

(76) Inventor: James Harrison, Fort Worth, TX (US)

Correspondence Address: Mr. James Harrison, 1734 Martel Avenue, Fort Worth, TX, 76103, US

(21) Appl. No.: 10/266,254

(22) Filed: Oct. 8, 2002

(51) Int. Cl. B68G 1/00

(52) U.S. Cl. 54/44.7

(57) ABSTRACT

A fully adjustable saddle tree for use with the JaHar Saddles™ for implementation on equine members of the horse and mule, as well as pony and ass, in either English or Western styles. Adjustable to fit the individual horse, with a custom fit being accomplished individually to each animal and to each rider. It may even be used as a pack saddle frame.

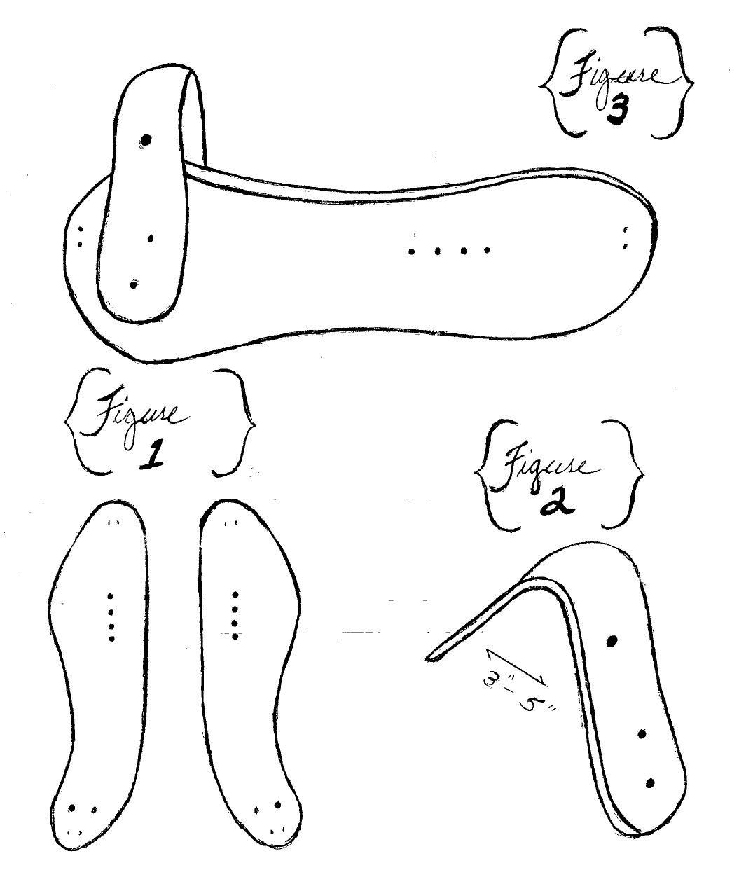

The invention combines aspects never before seen into a very functional design which may be readily modified to a wide range of variances and accomplishes a custom fit for both horse and rider.

All adjustments and modifications are accomplished with common hand tools, without specific knowledge or skill of saddle making.

### CROSS REFERENCE TO RELATED APPLICATIONS

Prior art shows attempts by many inventors to introduce into utility the design capabilities of saddle trees with aspects which allow for a certain amount of adjustability which are either flexible or adjustable by many means or apparatus, as in U.S. Pat. No. 5,884,459 and other attempts as in U.S. Pat. No. 5,274,986 and U.S. Pat. No. 5,383,328, and U.S. Pat. No. 4,745,734, and even U.S. Pat. No. 6,044,630 of which all are excellent examples of adjustability in one area, but fall short of answering all of the problems associated with adjusting a saddle tree to a true custom fit for both horse and rider.

After many years of testing the present tree design, perfected in the year 2002, the JaHar Saddle Tree, presents innovations not seen before which allow for a wide range of settings for the horses needs as well as seat size for the rider and therefore is a major Improvement on the design presently in use by this inventor's organization listed herein as JaHar-Saddles (TM).

### THERE WAS NO FEDERAL SPONSORSHIP OFTHE RESEARCH AND DEVELOPMENT OF THIS INVENTION.

### BACKGROUND OF THE INVENTION

This invention relates to the field of equine performance saddle trees and particularly to saddle trees which claim adjustable features to improve the fit to the horse.

### HISTORY OF THE FIELD OF THE INVENTION

A human rider upon the back of a horse is two unnatural acts coming together at human insistence. Prior to the late period of the first millennium BCE and the era when the Ethiopians introduced the first stirrups, saddles were not linked to a stirrup and only provided protection against impact of the rider's Coccyx, with the spine of the horse.

The introduction of the stirrup required a rigid frame or “tree” to anchor the stirrup straps and allow the rider to perform many tasks not previously available. This was a marked improvement over the saddle pad previously in use, as in the Roman Cavalry which did not use a stirrup. It is widely believed that the Ethiopians modified the pack saddle from the camel saddle, at the insistence of the need of a rigid tree to anchor the stirrup leather and create an entirely new set of abilities of the rider. The Charioteer gave way to the mounted individual as a result of these innovations. The Vandals in the early 5th century and later the Goth and Visagoth troops sacked Rome off the backs of horses using rigid trees and stirrups. Contrary to the imagery depicted by popular myth, the North American Plaines Tribes used a semi-rigid tree with a stirrup; Gen. William Tecumseh Sherman declared them the “worlds finest light cavalry”. A rigid tree, is essential to an anchored stirrup. The stirrup determined the horseman's effectiveness.

Saddle Fit

The needs of a rider for a stirrup having given rise to the rigid tree made a close fit of the saddle to the horse a necessary addition. Since the introduction of these innovations a well fitted saddle has been the most important necessity of which the remedy has been the most elusive.

The difficulties inherent in attempting to use a saddle tree that is not custom fitted to a specific horse; fit any other horses, has been the major obstacle to the accomplishment of the end because those trees were not adjustable from one animal to another, they were “set” to one size.

A poorly fitting saddle has been the cause of many problems which may manifest themselves by many venues. There is no replacement for a well fitted saddle which only can be accomplished with a well fitted tree.

The entire objective of the “fit” is to assure that the weight of rider or pack is supported by the most amount of muscle tissue on the equine back without applying any direct pressure to the bone structure.

These muscle groups which support the weight of rider or pack are known as a layered structure with the Longissimus Dorsi on the upper layer, with the Serratus Dorsalis and Serratus Caudalis muscles under this layer all of which anchor at different points of the underlying bone structure and angle to and at different directions, all supporting the weight of saddle and rider.

It is essential for a proper fit that this be the case.

### BRIEF SUMMARY OF THE INVENTION

An Equine performance saddle tree with an adjustable fork, and adjustable cantle section, and adjustable seating. The invention is presented as a “forward seat” or “English” model but the invention is applicable to the “Western” style saddle as well. It is presented here for use on Horses and Mules, but may be scaled to ponies and asses as well.

### BRIEF DESCRIPTION OF THE DRAWINGS

### Each page of the drawings, a total of Two (2) are identified as below.

### Page ______ of Drawings

### Jake Harrison Saddles and Equipment Inc.

### d.b.d. JaHar-Saddles

### Texas Corporation Charter No. 0128569-0

### Inventor: James Harrison

### 1734 Martel Avenue, Fort Worth

### Tex. 76103

### Ph. 817-535-4647 Fx. 817-535-5528

Description of Drawings begins; page 1,:

FIG.-1, depicts the two lateral span pontoons known as “Bars” a left and a right with preset holes.

FIG.-2, depicts the “Pommel Brace” with a possible 3-5 inch spread at the fork, or where the bars meet the withers of the horse at the dorsal spine junction.

FIG.-3, depicts the partially assembled tree with “Pommel Brace” bolted down to the front of the bars, or the “fork”, via preset holes.

Page 2,

FIG.-1, depicts the “Pedestal” each unit containing two (2) a left and a right or mirrored images.

FIG.-2 depicts the “Cantelette” with avariance of seven to ten (7-10) inches.

FIG.-3 depicts the fully assembled tree, with “Pommel Brace”, “Pedestals” and “Cantelette” installed.

Since other modifications and changes varied to particular operating requirements and environments will be apparent to those skilled in the art the invention is not considered limited to the examples chosen for the purposes of disclosure and coverts all changes and modifications which do not constitute a departure from the true spirit and scope of this invention.

1. I, James Harrison, claim as my invention the following equine performance saddle tree which has been known as the. “Jahar-Saddle Tree” since June of 2002:
1.) A Saddle Tree consisting of two lateral span pontoons, a left and a right known as bars, made of molded polynylon, which are joined at the front six to eight (6-8) inches inward from the tips by a . . .
2.) “Pommel Brace” made of molded Titanium steel alloy, carbon steel, or aluminum alloy in a preset width forming the front section or fork where the bars of the tree meet the withers of the horse. The tree is joined at the back section six to eight (6-8) inches inward from the tip by a . . .
3.) “Cantelette” made of sheet steel and varying in width from seven to ten (7-10) inches.
The “Cantelette” spans the lateral distance between the bars at the back section and is attached via preset holes with steel bolts to . . .
4.) TWO (2) “Pedestals” mirrored images made of steel flat stock and set at a forty (45) degree angle via preset holes to each of the bars completing the connection forming the cantle section of the adjustable tree.
5.) By installing “Pommel” braces of various preset distances of width at the fork, and installing “Canteletes” with various widths, a closer fit is accomplished to accommodate the individual horses needs.
Moving the pedestals forward or backward along the preset holes in the bars will allow for a wide variety of seat sizes.
This is the JaHar-Saddle Tree.
